(19) United States
(12) Patent Application Publication
(10) Pub. No.: US 2026/0335790 A1
(43) Pub. Date: Oct. 29, 2026

(54) Combined Vacuum,- Three Phase Separator-, and Tank Cleaning-System

(71) Applicant: Frank Roar Eriksen, Stavanger (NO)

(72) Inventor: Frank Roar Eriksen, Stavanger (NO)

(21) Appl. No.: 19/171,299

(22) Filed: Apr. 6, 2025

(51) Int. Cl. B01D 21/00; B01D 21/24; B08B 9/093; C02F 1/00; C02F 1/40; C02F 101/32; C02F 103/34

(52) U.S. Cl. CPC B01D 21/0045; B01D 21/0012; B01D 21/0018; B01D 21/2461; B08B 9/0933; C02F 1/40; B08B 2209/08; C02F 2001/007; C02F 2101/32; C02F 2103/34; C02F 2303/24

(57) ABSTRACT

A machine that can do three different jobs, separately or simultaneously. 1. Automatic tank cleaning (with water recirculation), 2. vacuum suction and 3. separating wastewater into two or three phases. All functions are built into one and the same tank.

### FIELD

This application relates to a machine that can do three different jobs, 1. Automatic tank cleaning, 2. vacuum suction and 3. separating wastewater

### BACKGROUND

Traditionally on-board oil rigs or other production facilities, an industrial vacuum cleaner is used to suck up spills as well as, for example, cleaning water. Water mixed with waste (the mixture is called “slop”) is sucked up and normally pumped to large slop tanks where it is stored until it can be sent to landfill or disposal. Sometimes an additional slop separator system is used to concentrate the waste (i.e. separate out the water) to reduce the amount that must be sent to landfill or disposal.

The problem the invention solves is that it substantially reduces and concentrates waste to be sent for destruction (such as oil and contaminated sand), and it purifies the water enough to be reused as cleaning water. Because the invention replaces three large machines that are often used on the same installations/plants, the area requirements, transport needs, maintenance and weight are reduced to approximately ⅓ compared to having three separate machines.

### SUMMARY

A machine that can do three different jobs, separately or simultaneously. 1.Automatic tank cleaning (with water recirculation), 2. vacuum suction and 3. separating wastewater into two or three phases. All functions are built into one and the same machine/tank that can be mobile or permanently installed. The machine separates at the same time as it sucks, and it has the possibility of pumping out separated water and sediments from the separator tank while working as a vacuum cleaner.

### DESCRIPTION OF FIGURES ATTACHED:

The invention is shown in FIGS. 1-3, which show a cross-section of the invention.

FIG. 1 shows the invention when working as an ATC Unit and cleaning tanks. The figure shows, by use of arrows, how the fluid flow goes through the invention.

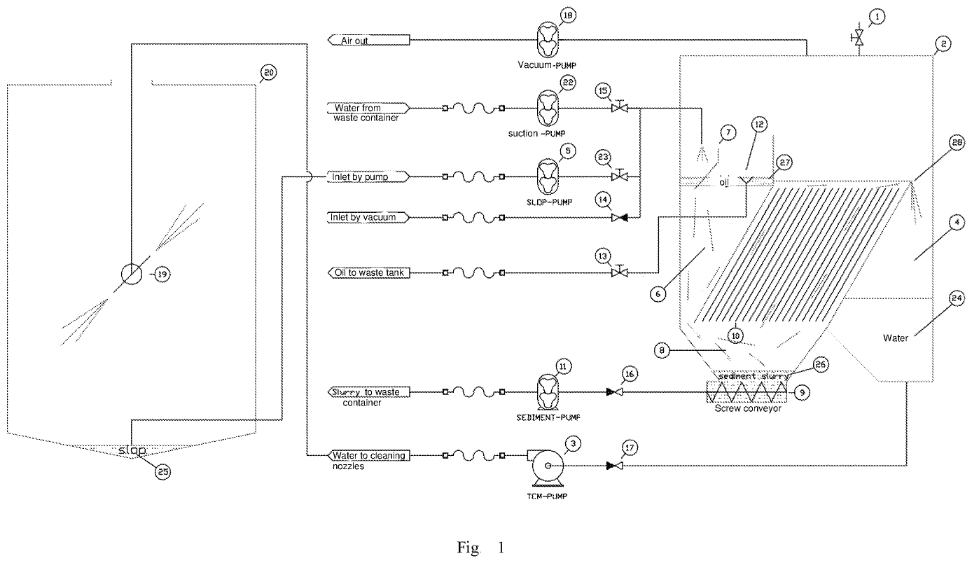

FIG. 2 shows how the invention is connected to a waste container. This connection is the same in all three modes (ATC unit, Slop separator and Vacuum unit).

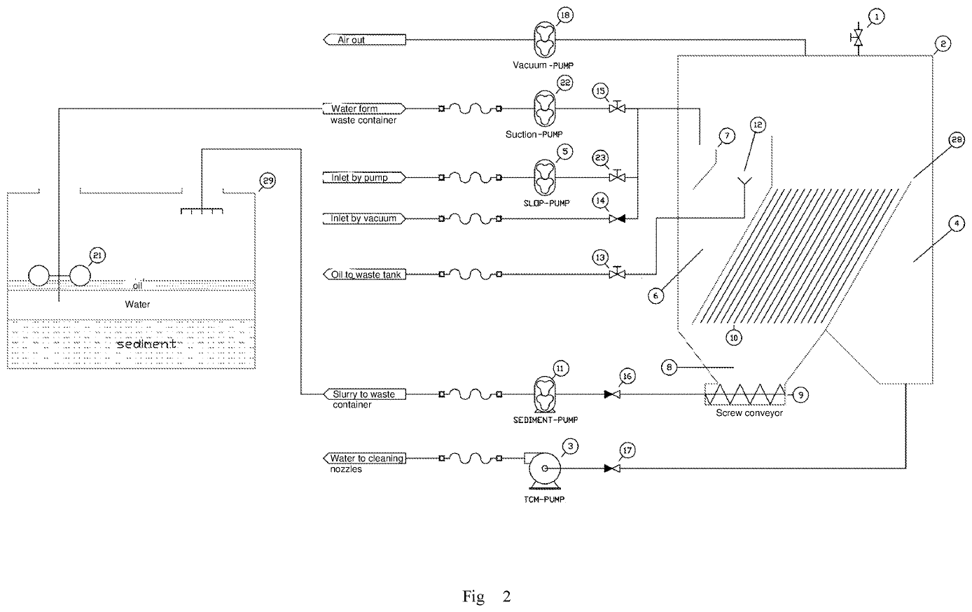

FIG. 3 shows how the invention is connected when it works as a Vacuum Unit.

The points in each figures are the same.
1. Breather valve
2. Separator tank
3. TCM pump
4. Chamber for clean/separated water
5. Slop pump
6. Inlet chamber
7. Diffuser
8. Sediment-hopper
9. Screw conveyor
10. Lamella plates/coalescing media
11. Sediment pump
12. Oil-trap
13. Valve for draining oil trap
14. Valve for vacuum suction
15. Valve to isolate suction pump
16. Valve to isolate sediment pump
17. Valve to isolate TCM pump
18. Vacuum pump
19. Tank Cleaning Machine (TCM)/cleaning nozzles
20. Tank being cleaned
21. Suction pipe
22. Suction pump
23. Valve for isolating slop-pump
24. Clean/separated water
25. Slop
26. Sediment slurry
27. Oil
28. Horizontal edge/weir
29. Waste container
30. Suction lance

### DESCRIPTION

The invention is a machine that can do three different jobs, separately or simultaneously. The invention may do the following:
1. Vacuum up sludge, spills and other wet waste in liquid or slurry form. The machine can.

Either suck this using a suction pump (displacement pump) or suck it by means of negative pressure/vacuum. The machine can also have vacuum provided by pump/vacuum systems outside the machine.
2. Separate the liquid or slurry into two or three phases (for example, oil, water and sand).

The three phases can be pumped out separately in three different outlets, allowing the waste itself to become concentrated before being sent for disposal or reuse.
3. Act as automatic tank cleaning system for internal cleaning of large industrial tanks and other closed containers. The machine then sends pressurized wash water through rotating tank cleaning nozzles used to clean the internal surfaces of a tank. At the same time, dirty cleaning water is sucked back to the machine, purified, recycles and sendt back to the nozzles. The concentrated waste separated from the wash water is sent to a waste container.

### More Detailed Description of the Invention

The invention consists broadly of an ATC Unit (ATC=Automatic Tank Cleaning) that has been modified to also work such as Vacuum Unit and Slop separator Unit

The invention consists of a closed tank with inlets and various internal chamber walls that direct fluid flow through the machine allowing water, oil and heavy sediments to go in different directions and be taken out separately. The separated water, often mixed with cleaning chemicals, inside the machine is picked up by a powerful pump and reused for cleaning purposes/tank cleaning. The pump provides sufficient pressure and volume flow for effective tank cleaning by rotating nozzles. A self-priming slop return pump sucks the dirty wash water back into the machine a little faster than it is pumped through the cleaning nozzles. This to avoid building up a liquid level inside the tank that is being cleaned. The sediment pump pumps the gravity separated waste continuously into a waste container. Inside the waste container time and gravity will allow more water to separate from the waste. This water is pumped back to the invention by the suction pump and a suction pipe that is just penetrating the oil level inside the waste container.

When the machine works as a slop separator unit, the process is similar to that of the ATC unit, but instead of using the water for cleaning, the separated water is pumped where it is needed, to a storage tank or to the drain/overboad (if the purity is satisfactory)

When the machine works as a vacuum unit, all outlets are closed, and a vacuum pump creates negative pressure inside the machine. The negative pressure is used to suck in liquid and spills via a suction hose, comparable to a vacuum cleaner. Inside the machine, water, oil, and sediments are separated. Water and sediments can be pumped out at the same time as the machine is working and under vacuum. When the suction is over, the vacuum inside the machine can be equalized, and then oil can also be drained from an oil trap.

When the machine works as an ATC Unit, it works like this: The breathing valve (1) is open so neither pressure nor vacuum can be built up inside the separator tank (2). TCM pump (3) takes the separated water (24) from the clean water chamber (4) and pumps it with pressure via pipes/hoses to one or several cleaning nozzles/TCMs (19) placed inside the tank being cleaned (20). Water can be mixed with cleaning chemicals if necessary. All connections to the machine are made with pipes, hoses or a combination of pipes and hoses. The cleaning nozzles (19) clean the dirty tank's (20) internal surfaces according to a selected cleaning pattern, while a slop pump (5) suck back the dirty wash water and sediments (altogether called slop) (25) from the bottom of the tank (20) being cleaned. The slop is then pumped into the separator tank's (2) inlet chamber (6) via a diffuser system (7) aimed at reducing turbulence and foaming. When more and more slop is pumped into the inlet chamber (6), the slop flow is forced to go slowly into a sediment hopper (8) where the heavy fractions called sediment falls out to the bottom of sediment hopper (8) and further into the screw conveyor (9). The water that now contains very little heavy particles, is pushed further up through the lamella plates (10) (coalescing media), where further fallout occurs. When the water has passed through the lamella plates (10), it flows over a horizontal edge/weir (28) and back into the clean water chamber (4) where from there can be reused for cleaning.

The sediments that end up in the screw conveyor (9) are fed out to the side and pumped by the sediment pump (11) as slurry (26) to a waste container (29). When this slurry ends up in the waste container, its components, water, oil and the heavy particles begin again to separate into three phases. A suction pipe penetrating the oil phase is then used (21) together with the suction pump (22) to pump the water phase of the waste container back to the inlet chamber (6). Inside the inlet chamber (6), oil (27) flows up to the surface where there is an oil trap (12) that can be adjusted vertically. The oil (27) is drained out regularly with valve (13).

When the invention works as a slop separator, it works in the same way as when it operates as ATC Unit, with the following exceptions: 1. The slop pump (5) sucks slop from a slop tank/container. TCM pump (3) acts as a transfer pump that pumps the separated water to a storage tank or further processing/metering before it goes to sea or to drain.

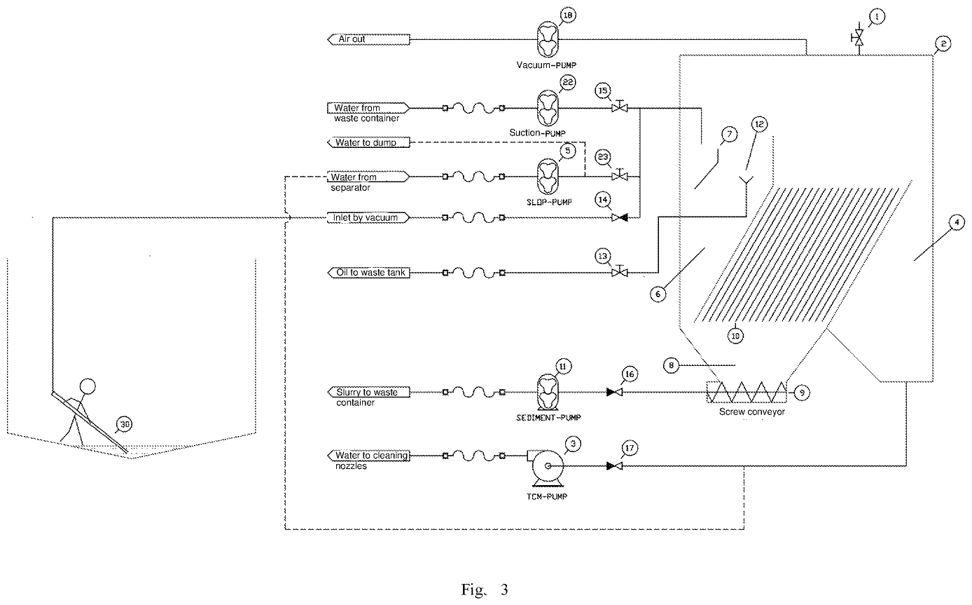

When the invention works as a vacuum unit, valves (1), (13), (15), (16), (17) and (23) in direction into separator tank (2) are closed. The vacuum pump (18) is then started, and spills/waste/liquids are sucked in to separator tank (2) through valve (14). This is normally done with a handheld suction lance (30) mounted on a hose. Sediment pump (11) together with the screw conveyor (9) can pump slurry (26) to waste container while the machine is working as a vacuum vacuum unit. TCM Pump (3) cannot be used when there is vacuum in the separator tank (2). If water is to be pumped to tank/dump at the same time as the machine works as a vacuum unit, it is done with the slop pump (5). A dotted line in FIG. 3 shows how the slop pump (5) is given a new task while the machine is working as a vacuum cleaner. Valve (23) is closed and the slop pump's (5) suction is connected to the separated water compartment (4) using hoses or pipes (dotted line). The slop pump (5) can act as a water transfer pump while there is vacuum inside the separator tank (2).

Pumping out water and sediments while keeping the separator tank (2) under vacuum requires that the slop pump (5), which now acts as the transfer pump, and the sediment pump (11), create higher vacuum than the vacuum pump (18).

1. A closed tank (2) for automatic tank cleaning with water recycling, vacuum suction and separation of waste water, consisting of;
Three chambers, inlet chamber (6), chamber with lamella plates (10) and chamber for clean/separated water (4), connected by a common layer of air above, which allows pressure regulation of the entire tank with a vacuum pump (18);
a diffuser (7) in the inlet chamber to reduce turbulence and foaming;
an oil trap (12) for draining oil layer;
a sediment hopper (8), located below and connected to the inlet chamber and lamella plate chamber, through which the liquid is propelled when the liquid level rises in the inlet chamber (6);
a screw conveyor (9) in sediment hopper (8) and sediment pump (11) for sediment slurry (26) removal;
an assembly of lamella plates (10), through which the fluid is propelled as it leaves sediment hopper (8);
an overflow/horizontal edge (28) where the separated liquid is driven over and into the clean/separated water chamber (24);
a pump for pumping out and reuse of separated water for the tank cleaning process or for storage in another tank.

2. A machine in accordance with requirement 1, which can pump out separated water and sediments from the separator tank (2) at the same time as the invention works as an industrial vacuum, in that the sediment pump (11) and slop pump (5) suck at a lower pressure than the pressure in the separator tank (2) created by the vacuum pump (18), while the pressure in the separator tank (2) is equalized by the addition of new water and sediments through a valve for vacuum suction (14).
